(19) United States
(12) Patent Application Publication
(10) Pub. No.: US 2007/0246643 A1
(43) Pub. Date: Oct. 25, 2007

(54) Surface Analysis of an Elongated Object

(75) Inventor: Jean-Francois Fardeau, Les Pennes Mirabeau (FR)

Correspondence Address: OLIFF & BERRIDGE, PLC, P.O. BOX 19928, ALEXANDRIA, VA, 22320, US

(73) Assignee: Jean-Fancois Fardeau, Les Pennes Mirabeau (FR)

(21) Appl. No.: 11/632,400

(22) PCT Filed: Jul. 18, 2005
(86) PCT No.: PCT/FR05/01832

§ 371 Date: Feb. 7, 2007

(30) Foreign Application Priority Data
Jul. 16, 2004 (FR) 0407893

(51) Int. Cl. H01J 40/14

(52) U.S. Cl. 250/222.1

(57) ABSTRACT

A number of luminous sources (4) are arranged in a ring-shaped manner in a plane and individually and successively emit, in a rotating manner on the ring, an incident beam oriented toward the axis (5) of the ring and diagonal to this axis at an angle that is not a right angle. This beam is reflected by the object (2) placed essentially along the axis (5), whereupon it is received by one of the photodetectors (8a, 8b, 8c) situated in a plane parallel to the ring of sources. The presence of a shape defect of a surface irregularity or of a variation in color is determined by modulating the energy received by the photodetectors. This measure provides a very good resolution of the successive lighting of very small areas of the object surface.

The present invention relates to a device and a method of analyzing the surface condition of an elongated object such as a wire, a fiber, a cable, a long extrusion, or similar. The main application relates to production lines, normally producing at high speed. The invention consists in measuring the surface condition (roughness), detecting surface defects (appearance), defects of shape and color, and in a very fine manner, and in characterizing them (surface, shape).

Already known are devices intended for the detection of defects on the surface of a wire or of a pipe.

Document EP 0 841 560 describes an appliance into which a plastic pipe is introduced in order to check its surface condition. Six fixed light sources are positioned in a circle concentric to the pipe. The permanent lighting of the sources, in a radial manner, illuminates an annular portion of the pipe over a short axial length. Each of the six sensors distributed about the pipe receives the light diffused by the latter from the six permanent sources.

A shape defect on the surface of the pipe is detected by the modulation of the overall energy received by the sensors, without it being possible to accurately determine its location or its surface area. The appliance described in document EP 0 841 560 does not therefore offer a good resolution. It is limited to revealing the presence of a significant defect but does not accurately detect the location and the size of this defect. It does not meet the performance requirements of the target applications.

The devices described in documents U.S. Pat. No. 4,616,139 and U.S. Pat. No. 4,645,921, although constructed differently, present the same similarities and limitations.

Document EP 0 119 565 describes a different optical inspection device for locating surface defects in cables. A light source deflected by an oscillating mirror is directed in turn to different fixed mirrors which, in turn, reflect the light towards the cable. Each fixed mirror returns divergent beams, so producing a sequential sweep of as many sections of cable as there are mirrors. The light diffused by the cable is captured by two sensors placed in two integrating hemispheres. The defects are observed by the energy that they diffuse throughout the space. The sequential sweep should make it possible to locate the defect on the surface. However, the illumination is not radial and the location depends strongly on the position of the cable. This device, like the others, exploits diffused energy, which varies in this case according to the incidence of the beam on the surface of the cable and which does not provide for a detailed characterization of the defects. Since it does not observe the direct reflected energy, this device does not make it possible to characterize the state of quasi-mirror surfaces. Furthermore, the sweep frequency of this device does not easily reach 3 kHz.

The present invention aims to remedy the limitations of the abovementioned inventions and propose a device and a method for continuously analyzing, in a very detailed manner, the surface of an object, preferably cylindrical, measuring its surface condition (roughness), even a quasi-mirror surface, detecting and characterizing its defects (surface area, size, location).

To this end, and according to a first aspect, the invention relates to a device for analyzing the surface condition of an elongated object such as a wire or similar, comprising:
a plurality of light sources arranged roughly in a ring in a plane, said sources being designed each to emit a main incident beam oriented towards the axis of the ring, the object being intended to be placed in the vicinity of said axis such that an area to be analyzed of the surface of said object is placed on the path of the incident beams;
at least three photodetectors located in a plane roughly parallel to the ring of the sources;

the sources being arranged so that the main incident beams form with the axis of the ring an angle (α) that is not a right angle and not a zero angle, and the photodetectors being positioned such that each reflected beam formed by the direct and perfect reflection on the object of an incident beam can be partially received each of the three photodetectors.

The phrase “the reflected beam formed by the direct and perfect reflection” is understood to mean the beam that would be reflected by a defect-free surface area of the object (cylindrical), and would also form an angle a with the axis of the ring of the sources, symmetrical to the angle of the incident beam. In other words, the photodetectors are positioned so that they always receive a portion of the direct reflection of the sources on the object.

The cone of emission from the sources is wide enough to illuminate all of an area around the axis, called measurement area, with a spatial energy density that is roughly constant. The main incident beam corresponds to the main axis of emission.

Advantageously, but not necessarily according to the applications, the emitting area of the sources is preferably as small as possible, for example less than 5 mm², and typically less than 0.1 mm², producing a quasi-divergent beam and a single direct reflection seen from each of the three photodetectors. At a given instant, just one source emits. Only two photodetectors are active simultaneously according to the angular position of the emitting source, and therefore two different reflections of one and the same source are measured simultaneously. The photodetector in the angular position most nearly opposite to the emitting source is not active.

The single active source is switched sequentially from source to source in the ring to circularly sweep about the object the angular incidence of the source beams and so provoke the angular sweep of the reflections on the surface of the object. This method makes it possible to observe in detail and in sequence all the surface of the object, point-by-point, with the points accurately located.

The angular resolution (angular pitch) “Rf” of the points reflected on the surface of the object depends only on the angular resolution of the sources (Rs). Rf=Rs/2. The consequence of this is that the number of points on the object is two times greater than the number of sources. The spatial resolution “Rp” is itself proportional to the radius “r” of the objects, so Rp=r*Rf. The size of the points on the surface depends on the area of the source and the acceptance cone.

To obtain a good spatial resolution “Rp”, according to the applications, sources with a small emitting surface and small acceptance cones will be sought, in accordance with the sensitivity of the sensors, as will a number of sources appropriate to the required resolution.

Thus, the fact that the photodetectors receive the maximum of reflected light indicates the absence of a defect and characterizes the surface condition. It is therefore possible, with the device according to the invention, to perform an analysis of the entire surface of the object, including in the case of quasi-mirror wires.

Furthermore, the emission of light inclined by an angle α enables the sources not to generate spurious reflections on the opposite sources observed by the photodetectors.

Each photodetector has an associated optical system for collecting the reflected light energy, positioned between the photodetector and the measurement area.

The photodetectors and their optical systems will therefore be placed on the same axis, at an angle roughly symmetrical to the main angle of incidence of the sources relative to the axis of the ring and passing through the point of intersection between the main incident beams and the axis of the ring. The optical system must allow for variations of the position of the reflections when the object oscillates in the measurement area.

The optical system and the sensitive surface of the sensor define an acceptance cone, which determines the size of the reflections observed on the object and therefore the resolution of the measurements. This arrangement makes the measurement relatively independent of the vibration or the position of the object relative to the axis of the ring.

The plane of the photodetectors is, for example, roughly symmetrical to the plane of the sources relative to the point of intersection between the incident beams and the axis of the ring.

The device comprises means intended to provoke the individual and successive activation of the sources in a localized and rotating manner on the ring, in order to generate a rotating incident beam to provoke rotating reflections on the surface of the object towards the photodetectors. It can, where necessary, make it possible to regulate the light power emitted by each source in order for all the sources of the ring to emit a constant energy, whatever their individual characteristics. The variations of the reflected energy then correspond only to the variations of the surface condition, roughness, shape, appearance, color.

The device can, furthermore, comprise a lens placed between each photodetector and the point of intersection between the main incident beams and the axis of the ring, to collect the energy reflected by the object and direct it to the photodetectors.

The main applications of the device concern production lines (drawing, extrusion, fiber forming) where the object advances on its axis at high speed. In this case, the sweep of the reflections on the surface of the object corresponds to a helix, the pitch (longitudinal or axial resolution) of which depends on the speed of rotation of the sources and the speed of advance of the object on its axis.

With, for example, 100 sources on the ring, switched at a frequency of 20 MHz, there are 20*10⁶/100=200 000 rotations per second around the object. If the object advances in production at the maximum speed of 30 meters per second, the longitudinal resolution on the object, between two rotations, would be 0.15 mm. The resolution on the circumference would be 200 points, two times the number of sources.

By linking the device to an external instrument supplying the measurement of the speed of the object, the displacement of the object is known at all times. The invention thus makes it possible to determine not only if there are surface defects, but also accurately determine their position and circumferential and axial dimensions. This device makes it possible to observe all the surface of a cylinder moving axially, by a helical sweep, point by point, of the surface of the object, and generate a developed image of this surface, very accurately and very rapidly. It is thus possible to produce a detailed analysis of the characteristics of the defects.

The device can have at least ten sources distributed roughly equidistant in a ring.

A toric lens can be placed between the ring of the sources and the axis of the ring, in a manner centered on said axis, in order to concentrate the incident beams into a fine line in the vicinity of the axis.

For example, the device comprises at least three photodetectors spaced at regular angles to each other.

It also comprises a device for acquiring and comparing signals from the photodetectors making it possible to measure the variations of the energy received by the photodetectors, locate their origin on the surface of the object and dimension the defects.

According to a second aspect, the invention relates to a method of analyzing the surface condition of an elongated object such as a wire or similar, comprising steps consisting in:
providing a plurality of light sources placed roughly in a ring, said sources being designed each to emit an incident beam oriented towards the axis of the ring and forming with said axis an angle (α) that is not a right angle and not a zero angle;
placing the object roughly on the axis of the ring, a roughly annular area to be analyzed of the surface of the object being placed on the path of the incident beams;
providing at least three photodetectors located in a plane roughly parallel to the ring of the sources, said photodetectors being positioned so that each reflected beam formed by the direct and perfect reflection on the object of an incident beam can be received by at least two of the three photodetectors;
individually and successively activating the sources, in a rotating manner on the ring, to produce a circumferential sweep of the reflections on the surface of the object received by the photodetectors which measure the received energy point-by-point.

A change of the surface condition, the presence of a defect of shape, an irregularity on the surface of the object, or a modification of the color of the surface of the object, is determined by measuring the variation of the energy reflected and received by at least two photodetectors.

The method can also comprise the step consisting in progressively displacing the object along the axis of the ring in order to analyze all the surface of the object by spiral scanning.

There follows a description, by way of nonlimiting example, of a possible embodiment of the invention, with reference to the appended figures:

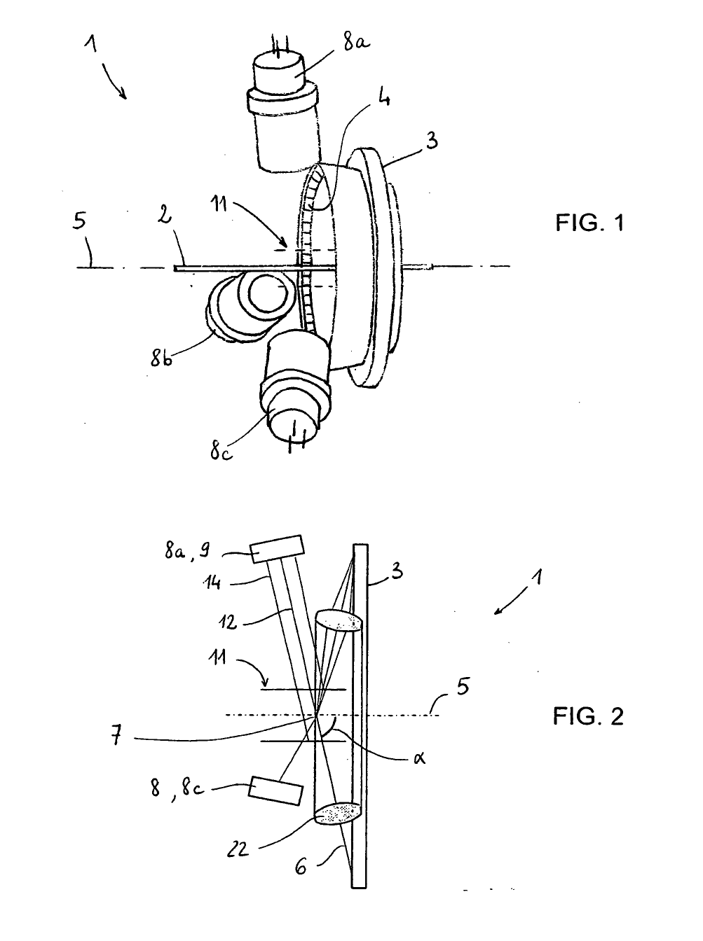

FIG. 1 is a perspective mode partial diagrammatic view of the device according to the invention;

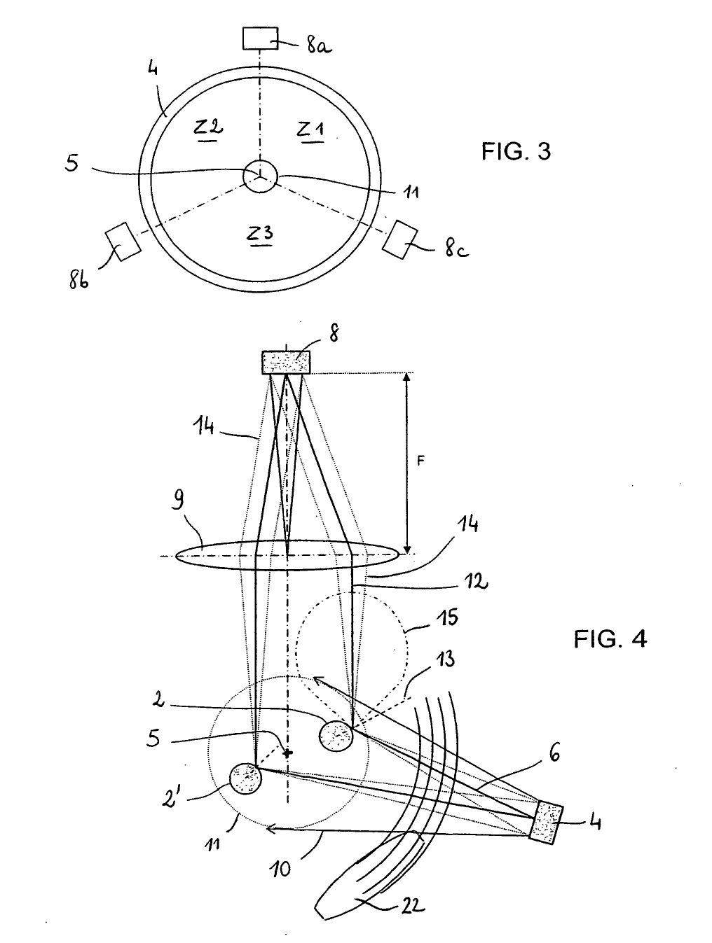

FIGS. 2 and 3 are partial diagrammatic views of the device of FIG. 1, seen radially, and respectively axially;

FIG. 4 is a partial view illustrating the principle of the measurement of the surface condition of a wire;

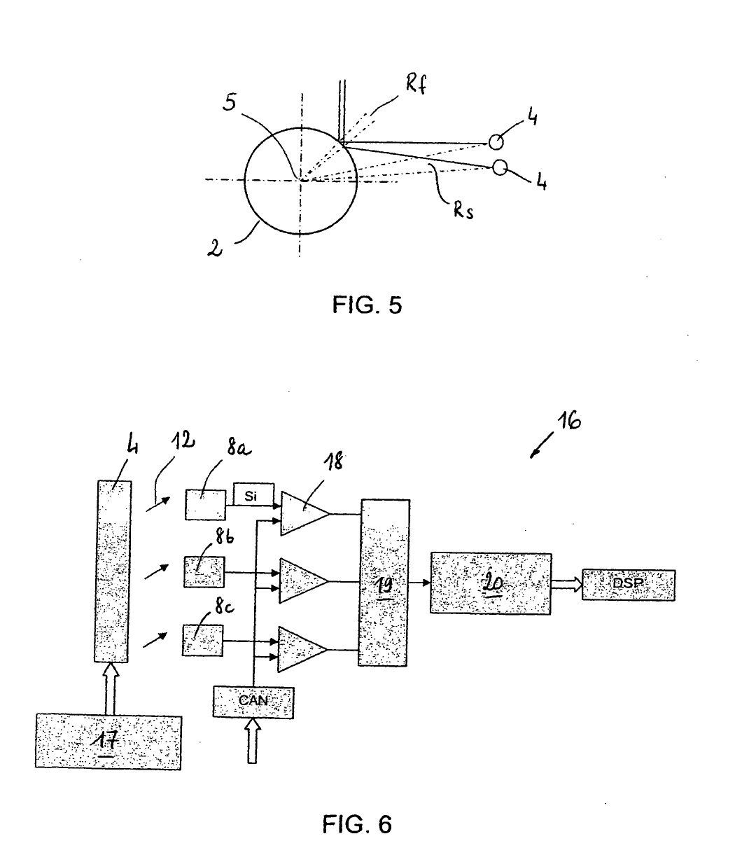

FIG. 5 illustrates the angular resolution of the sources and the angular resolution on the wire;

FIG. 6 is a diagram of an electronic device for processing signals received by the photodetectors from the device according to the invention;

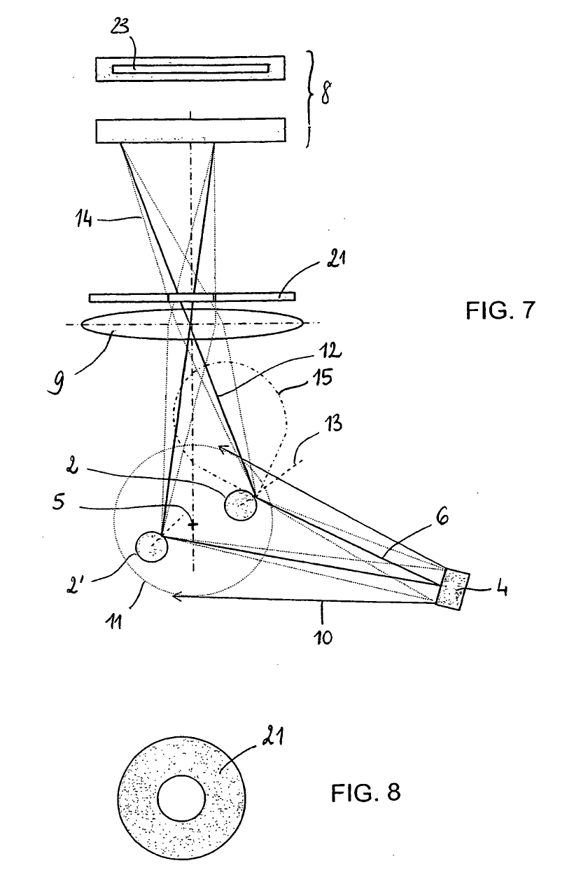

FIG. 7 is a view similar to FIG. 4, showing a variant with a diaphragm; and

FIG. 8 is a top view of the diaphragm of FIG. 7.

The device 1 makes it possible to inspect the quality of the surface of an elongated object, preferably, but not exclusively, round, such as a wire 2 or similar. The wire 2 is, for example, produced continuously, the analysis being carried out permanently at the point of exit from the line. It can, for example, be a metal wire (steel, stainless steel, etc.), an electrical copper cable, a perfectly reflecting wire (gold wire), an optical fiber, and so on, but also can be a long extrusion (bar, etc.).

The device 1 comprises a support 3 formed by a metal ring and a flexible printed circuit on which are mounted light sources 4. The sources 4 can be light-emitting diodes or laser diodes or small-size emitting devices. They are, in this case, LEDs in an SMC package measuring 1×1.5 mm of area with an emissive part with a diameter of 0.2 mm (0.03 mm²). The device 1 thus comprises a large number of sources 4, that can exceed 20, even exceed 50, positioned in a plane and distributed roughly evenly on a ring of axis 5 orthogonal to said plane.

As an example, the ring of the sources 4 can have a diameter of the order of 40 mm, for wires 2 of a diameter between 20 μm and 5 mm, preferably less than 2 mm. Larger or smaller dimensions can be imagined for particular applications.

The sources 4 each emit a main incident beam 6 oriented towards the axis 5 and inclined relative to the latter by an angle α greater than 70°, and, for example, of the order of 85°. The set of the incident beams 6 therefore forms a cone of summit angle α and summit 7. The summit 7 is the intersection between the incident beams 6 and the axis 5.

The device 1 also comprises three photodetectors 8a, 8b and 8c positioned in a plane roughly parallel to the plane of the sources 4 and symmetrical to the latter relative to the summit 7 of the cone formed by the incident beams 6.

An optical system consisting of a lens 9 and, where appropriate, a diaphragm 21 (FIG. 7) is also placed between each photosensor 8 and the summit 7 on the same axis, to collect and project onto the photodetector 8 the energy reflected on the object 2, in an appropriate manner.

The three photodetectors 8 and their optical systems are spaced at angles of 120° to each other. The conical emission area of the sources 4 enables the sources 4 not to generate spurious reflections on the opposite sources observed by the photodetectors 8.

The intersection of the set of the cones 10 of the incident beams 6 from the sources 4 defines a cylindrical area centered on the axis 5, called “measurement area 11”. The wire 2, the surface of which is to be analyzed, is placed in the measurement area 11, preferably orthogonal to the plane of the sources 4 and on the axis 5.

Two different configurations of the device are described.

In FIGS. 2 and 4, a toric lens 22 concentrates the incident beams 6 from the sources 4 into a fine line on the axis 5 and at right angles to this axis 5 throughout the measurement area 11. This toric lens 22 can be made of machined or molded plastic with performance characteristics and cost that are acceptable in volume terms.

An object 2 placed in the measurement area, parallel to the axis 5, will therefore be illuminated by a straight line on its circumference. All the reflected beams 12 on the object 2 that the photodetector 8 receives originate from this line which defines the axial resolution of the measurements on the object 2.

The photodetector 8 is in this case in the focal plane of the lens 9. The acceptance cone is then defined by the focal length F of the lens 9 and the sensitive area of the photodetector 8. Because of this, all the reflected beams 12 on the surface of the object 2, whatever the position of the object 2 in the measurement area (vibrations) are contained in an acceptance cone that is always oriented along the axis of the optical system. This makes the measurement relatively insensitive to the position of the object. This device is perfectly applicable to fibers, very fine wires, vibrating at high frequency.

In FIG. 7, the photodetectors 8 are in a linear form, oriented perpendicularly to the axis 5. They are placed at a distance from the lens 9 such that their images are projected in the center of the measurement area 11. An enlargement ratio of 1 is typically obtained. In this case, the energy reflected on the object 2 received by the photodetectors 8 corresponds to the area of the photodetectors 8 projected onto the object 2. The thickness of the photosensitive line 23 of the photodetector 8 determines the axial resolution on the object 2. The diaphragm 21 defines the acceptance angle and the length of the photodetector 8 determines the measurement area. This arrangement, simpler than that of FIG. 4, offers excellent axial and circumferential resolution but naturally leads to a greater incident energy requirement. It will be more applicable to extruded or fiber-formed products of average size.

The basic principle of the measurements is the same in the two configurations described above. It is as follows (in FIGS. 4 and 7, a single source 4 and a single photodetector 8 are shown for simplicity).

The incident beam 6 from a source 4 arrives on an area of the wire 2. If this area has a perfect surface condition (mirror), a reflected beam 12 is obtained that is symmetrical with the incident beam 6 relative to the normal 13 to the wire 2 at the reflection point concerned. After passing through the lens 9, the reflected beam 12 is directed towards the photodetector 8.

The surface condition of the wire 2 is measured by the greater or lesser diffusion of the reflected energy. If the wire is a mirror (gold wires, for example), most of the energy of the incident beams 6 will be included in the acceptance cone 14. If the surface is not perfect (roughness), it reflects the incident beams 6 in a diffusion cone 15 that is angularly far larger than the acceptance cone 14. At constant incident energy, the energy contained in the acceptance cone 14 will therefore be much lower, producing a strong modulation of the energy received by the photodetector 8.

For defects of surface shape, it is the change of reflection angle or localized absorptions in a crack that modulates the reflected energy. For colors, it is also possible to imagine having three photodetectors 8, with color filter, for each lens 9 to do the colorimetry (analysis of the light variations of the three basic color components), these three photodetectors 8 possibly being offset on the wire 2 or optically aligned.

During the analysis, each source 4 is activated individually and sequentially so as to perform a circular rotation of a single emitting source about the wire 2. It is thus possible to reveal the characteristics of the surface of the wire 2 by successive scans of detailed portions of the surface, since the reflection of just one source 4 at a time is observed via the photodetectors 8, over a small angular portion of the wire 2.

Using only solid-state components, the invention makes it possible to perform a very large number of rotations per second, limited by the technology of the moment. In the present application, the rotation frequency is 200 000 Hz, in line with the technologies used. The measurement is therefore very fast.

With FIG. 3, it can be seen that, according to the position of the active source 4 on the ring, separated into three areas, the active photosensors differ. Thus, in the area Z1, the photodetectors 8a and 8c are active, in the area Z2 the photodetectors 8a and 8b are active, and in the area Z3 the photodetectors 8b and 8c are active. Each of the two active sensors perceives a single reflection from one and the same source. In other words, two different reflections are perceived simultaneously.

In FIGS. 4 and 7, the wire is shown in another position inside the measurement area 11 (reference 2′), to show the impact of the position of the wire on the direction of the incident beams 6 and the reflected beams 12. If the wire 2 moves inside the measurement area 11, one and the same source 4 will not exactly illuminate the same part of the wire 2 for the same acceptance cone 14. Given that the energy of the sources 4 is very uniform within the measurement area 11, it can be seen that this arrangement makes the measurement relatively independent of the vibrations and the position of the wire 2 in the measurement area 11. This characteristic is very important, because this makes it possible to perform quality measurements even if the wire 2 is not perfectly centered on the axis 5 or if it is subject to vibrations at the very moment of the analysis. If the distance from the source 4 to the wire 2 is 50 mm, for a total vibration amplitude of the wire 2 of 4 mm, the angular variation of the observable reflection area on the wire 2 will be: 1/2.arctg (4 mm/50 mm)=2.3°, whatever the diameter.

If 86 sources 4 are placed in a circular manner about the wire 2, the angular resolution of the measurements on the wire will be 360°/(86×2)=2.1°.

The scanning time of a circumference is very short, of the order of 5 microseconds for example, so the vibrations of the wire 2 are proportionally very slow (1000 times less) and the analysis remains continuous even if a slow angular offset occurs when the wire 2 is moved.

An exemplary electronic device 16 for processing signals from photodetectors 8 is illustrated in FIG. 6. However, other electronic devices can be envisaged, and they can be as complex as is required according to the application.

The function 17 handles the logical switching of the sources, but also the regulation of the current, source by source, to maintain a constant energy emission whatever the dispersion of the individual characteristics of the sources 4. Thus, the variation of the energy of the reflected beams 12 received by the photodetectors 8a, 8b, 8c is caused only by the variations of the object (roughness, shape, appearance, color). In the case of the surface condition of a wire, all that will be needed will be three or four photodetectors 8 or optronics reception systems distributed at uniform angular intervals about the object to be checked.

Each signal from the photodetectors 8 is compared with a comparator 18, the comparison threshold of which can vary according to the relative position of the source 4. Depending on the active sensors, the outputs of the comparators 18 can be validated or not by the channel selection logic 19. When a defect is detected, a count can be initiated on the number of defective “points” per circumference but also on the number of circumferences in association with the axial speed of the object to have a two-dimensional measurement of the surface area of the defects of the wire 2 via the device 20, as long as the same sensor does not make a defect-free cycle.

In parallel to the comparators 18, the analog signals from the photodetectors can be recorded to generate a developed image of the surface of the wire around the defects for analysis or display purposes.

Thus, the invention adds a decisive improvement to the prior art, by providing a device for analyzing the surface condition of an object which, while being of simple and robust construction, makes it possible to analyze all the surface of the object, even in the absence of defects, and to accurately locate and quantify the defects of shape, surface irregularities and color variations. In fact, the location of the defects is known, unambiguously, according to the position of the source and of the sensors concerned.

It goes without saying that the invention is not limited to the embodiment described above by way of example, but that it, on the contrary, embraces all variants of embodiment.

1. A device for analyzing the surface condition of an elongated object such as a wire or similar, comprising:
a plurality of light sources arranged roughly in a ring in a plane, said sources being designed each to emit a main incident beam oriented towards the axis of the ring, and being arranged so that the main incident beams form with the axis of the ring an angle that is not a right angle and not a zero angle, the object being intended to be placed in the vicinity of said axis such that an area to be analyzed of the surface of said object is placed on the path of the incident beams;
at least three photodetectors located in a plane roughly parallel to the ring of the sources, the photodetectors being positioned such that each reflected beam formed by the direct and perfect reflection on the object of an incident beam can be received by at least two of the three photodetectors;
wherein it comprises means intended to provoke the individual and successive activation of the sources in a localized and rotating manner on the ring, in order to generate a rotating incident beams to provoke rotating reflections on the surface of the object towards the photodetectors.

2. The device as claimed in claim 1, wherein it also comprises a lens placed between each photodetector and the point of intersections between the main incident beams and the axis of the ring, to collect the energy reflected by the object and direct it to the photodetectors.

3. The device as claimed in claim 1, wherein it comprises at least ten sources distributed roughly equidistant in a ring.

4. The device as claimed in claim 1, wherein it comprises a toric lens placed between the ring of the sources and the axis of the ring, centered on said axis, making it possible to concentrate the incident beams into a fine line in the vicinity of the axis.

5. The device as claimed in claim 1, wherein it comprises at least three photodetectors spaced at regular angles to each other.

6. The device as claimed in claim 1, wherein it comprises a device for acquiring and comparing signals from the photodetectors making it possible to measure the variations of the energy received by the photodetectors, locate their origin on the surface of the object and dimension the defects.

7. A method of analyzing the surface condition of an elongated object such as a wire or similar, comprising steps consisting in:
providing a plurality of light sources placed roughly in a ring, said sources being designed each to emit an incident beam oriented towards the axis of the ring and forming with said axis an angle that is not a right angle and not a zero angle;
placing the object roughly on the axis of the ring, a roughly annular area to be analyzed of the surface of the object being placed on the path of the incident beams;
providing at least three photodetectors located in a plane roughly parallel to the ring of the sources, said photodetectors being positioned so that each reflected beam formed by the direct and perfect reflection on the object of an incident beam can be received by at least two of the three photodetectors;
individually and successively activating the sources, in a rotating manner on the ring, to produce a circumferential sweep of the reflections on the surface of the object received by the photodetectors which measure the received energy point-by-point.

8. The method as claimed in claim 7, wherein a change of the surface condition, the presence of a defect of shape, an irregularity on the surface of the object, or a modification of the color of the surface of the object, is determined by measuring the variation of the energy reflected and received by at least two photodetectors.

9. The method as claimed in claim 7 wherein it also comprises the step consisting in progressively displacing the object along the axis of the ring in order to analyze all the surface of the object by spiral scanning.
